(19) United States
(12) Patent Application Publication
(10) Pub. No.: US 2026/0020116 A1
(43) Pub. Date: Jan. 15, 2026

(54) INSTANT HOT WATER MODULE FOR BIDET CLEANING

(71) Applicant: INUS Co., Ltd., Asan-si (KR)

(72) Inventors: Jong Won LEE, Bucheon-si (KR); Ji Sang YU, Seoul (KR)

(73) Assignee: INUS Co., Ltd., Asan-si (KR)

(21) Appl. No.: 19/268,421

(22) Filed: Jul. 14, 2025

(30) Foreign Application Priority Data
Jul. 15, 2024 (KR) 10-2024-0092784

(51) Int. Cl. H05B 6/10; E03D 9/08

(52) U.S. Cl. CPC H05B 6/10; E03D 9/08

(57) ABSTRACT

The present disclosure relates to an instant hot water module for bidet cleaning. which can clean with hot water instantaneously heated by heat generation of a metal plate by an induction heater without separately storing hot water.

### CROSS-REFERENCE TO RELATED APPLICATION AND CLAIM OF PRIORITY

This application claims priority to Korean Patent Application No. 10-2024-0092784 filed on Jul. 15, 2024 in the Korean Intellectual Property Office (KIPO), the entire disclosure of which is incorporated by reference herein.

### TECHNICAL FIELD

The present disclosure relates to an instant hot water module for bidet cleaning, which can clean with hot water instantaneously heated by heat generation of a metal plate by an induction heater without separately storing hot water.

### BACKGROUND

In general, water sprayed through a bidet needs to be maintained at a predetermined temperature so that a user does not feel uncomfortable, and the bidet usually includes a heating device for this purpose.

In order to use hot water when using the bidet, a hot water tank that always stores hot water must be installed inside the bidet, so the product becomes larger than necessary, and it requires a lot of cost for product packaging and transportation. Further, the water inside the bidet must maintain a predetermined temperature even when the bidet is not used, so energy must be continuously supplied, and there is a problem that bacteria may grow because the water is stagnant inside.

As a technology that has been developed to solve the problems, there is an instant hot water method that instantly heats water only when hot water is necessary, and uses hot water.

As an example of the instant hot water bidet, there is disclosed patent document (Korean Patent No. 10-2317769) entitled “Instant hot water module of bidet” (see FIGS. 10 to 12).

Referring to the patent document, as illustrated in FIG. 10, an instant hot water module 100 of a conventional bidet is installed between a pressure reducing valve 300 connected to a water supply and a flow path change valve 210 and a cleaning/bidet nozzle 200. The instant hot water module 100 includes an inlet side hot water chamber 110, an outlet side hot water chamber 120, a ceramic heater 130, an inlet side temperature sensor 140, an outlet side temperature sensor 140, an electronic pressure sensor 160, and a controller (not shown).

Referring to FIGS. 11 and 12, the inlet side hot water chamber 110 includes a water inlet 111 formed on one side in which depressurized direct water flows, and an inlet flow path 112 through which direct water flowing into the water inlet 111 flows in a zigzag pattern.

The outlet side hot water chamber 120 includes an outlet flow path 122 through which direct water passing through the inlet side hot water chamber 110 flows in a zigzag pattern, and a water outlet 121 formed on one side so that water that passes through the outlet flow path 122 and is converted into hot water is discharged to the cleaning/bidet nozzle 200.

The ceramic heater 130 is installed between the inlet side hot water chamber 110 and the outlet side hot water chamber 120 and may heat water passing through the inlet flow path 112 and the outlet flow path 122.

However, when water is heated by the ceramic heater 130, power consumption is large, and temperature control precision is low. Above all, a component that applies current to the ceramic heater 130 is complex, which may limit miniaturization.

Further, since the ceramic heater 130 uses a method of heating water by current through a wire, the ceramic heater 130 may not function if the wire is disconnected.

In addition, since the wire of the ceramic heater 130 must be drawn out, the layout of multiple components for sealing with the chambers may become complicated.

In addition, since the water inlet 111 and the water outlet 121 are respectively formed in the inlet side hot water chamber 110 and the outlet side hot water chamber 120, a thickness of the inlet side hot water chamber 110 and a thickness of the outlet side hot water chamber 120 may increase by a diameter of the water inlet 111 and a diameter of the water outlet 121.

Since there is no heat dissipation structure for dissipating heat from the controller (not shown), the heat must be dissipated in a wider occupied space, which may hinder miniaturization.

In addition, since tap water is directly taken into the water inlet 111, more power may be consumed to heat the water that has not been preheated.

### PRIOR ART DOCUMENT

### Patent Document

(Patent Document 1) Korean Patent No. 10-2317769 (published on Oct. 27, 2021)

### SUMMARY

The present disclosure has been made to solve the above-described problems and provides an instant hot water module for bidet cleaning, which heats water with the heat generation of an induction heater, thereby enabling miniaturization, reduction in power consumption, and precise temperature control.

In order to achieve the above-described and other objects, there may be provided an instant hot water module for bidet cleaning comprising a chamber including an inlet of water and an outlet of hot water, a metal plate separating an inside of the chamber into an inlet flow path and an outlet flow path, and an induction heater arranged to be in contact with the chamber, the induction heater allowing the metal plate to generate heat by a magnetic induction phenomenon and heating the water.

Effects of an instant hot water module for bidet cleaning according to the present disclosure are described as follows.

Since a metal plate generates heat by an induction heater to instantaneously heat the flowing water, power consumption can be reduced, the precision of temperature control can be improved, and miniaturization can be achieved by simplifying components.

In addition, a magnetic induction direction of a magnetic induction coil can be focused upward by placing a magnet on the bottom of the magnetic induction coil, thereby greatly increasing energy efficiency.

In addition, since both a water inlet and a water outlet are formed in a one-side chamber, a thickness of an other-side chamber can be reduced, thereby achieving miniaturization and weight reduction.

In addition, as a magnetic induction coil is arranged to be in contact with a chamber, increased thermal energy of the magnetic induction coil can quickly increase a water temperature in a chamber.

In addition, since the supply water is supplied to an induction heater after cooling a heat dissipation plate, the heat generation of a printed circuit board (PCB) can be minimized by cooling the heat dissipation plate, thereby realizing miniaturization of the PCB.

In addition, since there is no wire supplying current to a metal plate, the chamber configuration is simplified by only placing the metal plate inside the chamber, and there is no problem such as sealing, and the problem of wire disconnection can be completely eliminated.

### BRIEF DESCRIPTION OF THE DRAWINGS

The accompanying drawings, which are included to provide a further understanding of the disclosure and are incorporated in and constitute a part of the disclosure, illustrate embodiments of the disclosure and together with the description serve to explain the principle of the disclosure.

FIGS. 1 and 2 are perspective views of an instant hot water module for bidet cleaning according to an embodiment of the present disclosure when viewed from up and down.

FIG. 3 is an exploded perspective view of FIG. 1.

FIG. 4 is an exploded perspective view illustrating an induction heater of FIG. 3.

FIG. 5 is a combined side view of FIG. 4.

FIGS. 6 to 9 are plan views illustrating a path from the intake of water to the discharge of water.

FIG. 10 is a conceptual view to which an instant hot water module of a conventional bidet is applied.

FIG. 11 is an exploded perspective view of an instant hot water module of a conventional bidet.

FIG. 12 is a combined cross-sectional view of FIG. 11.

### DETAILED DESCRIPTION OF THE EMBODIMENTS

Hereinafter, preferred embodiments according to the present disclosure will be described in detail with reference to the accompanying drawings. Before describing the embodiments, the terms or words used in the present disclosure and claims should not be interpreted as limited to their usual or dictionary meanings, and should be interpreted as meanings and concepts that conform to the technical idea of the present disclosure based on the principle that the inventors can appropriately define the concept of the term in order to explain their own invention in the best possible way.

Accordingly, the embodiments described in the present disclosure and the configurations illustrated in the drawings are only the most preferred embodiments of the present disclosure and do not represent all the technical ideas of the present disclosure, so it should be understood that there may be various equivalents and modified examples that can replace them at the time of this application.

In addition, the same reference numerals are given to components that are the same as those of the prior art, and detailed descriptions are omitted.

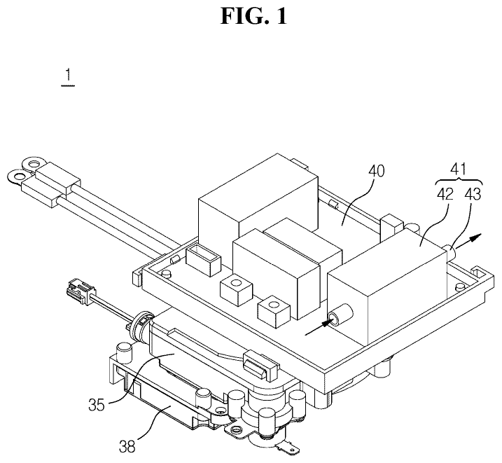

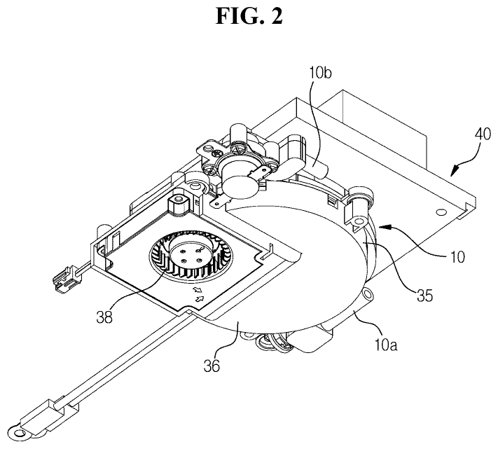

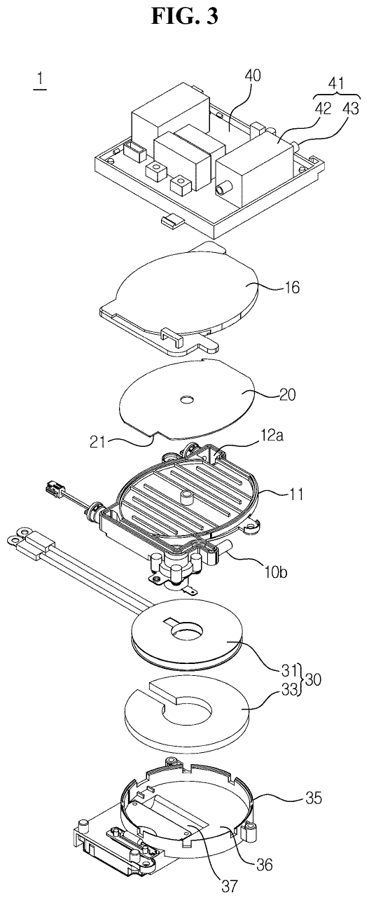

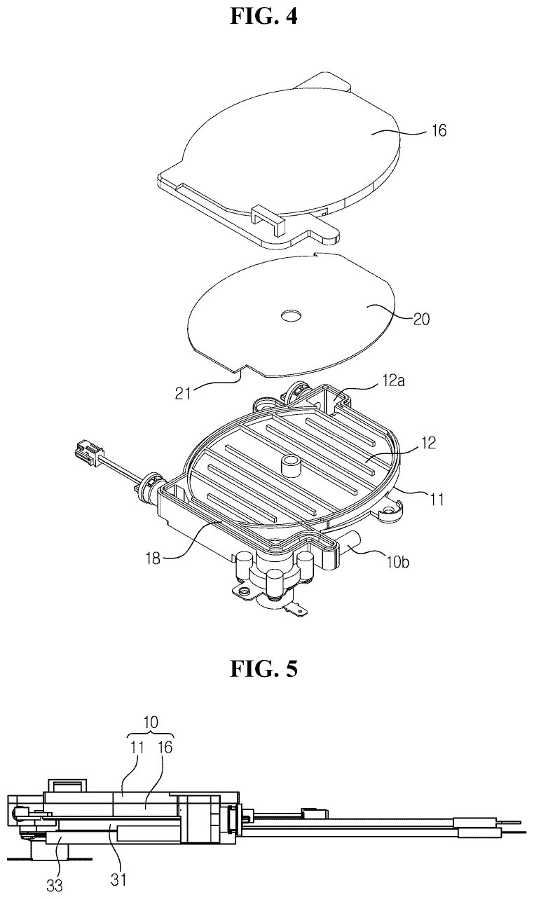

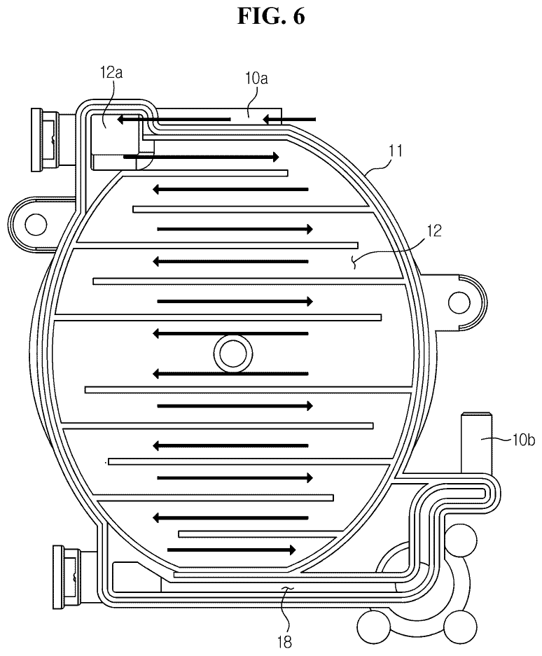

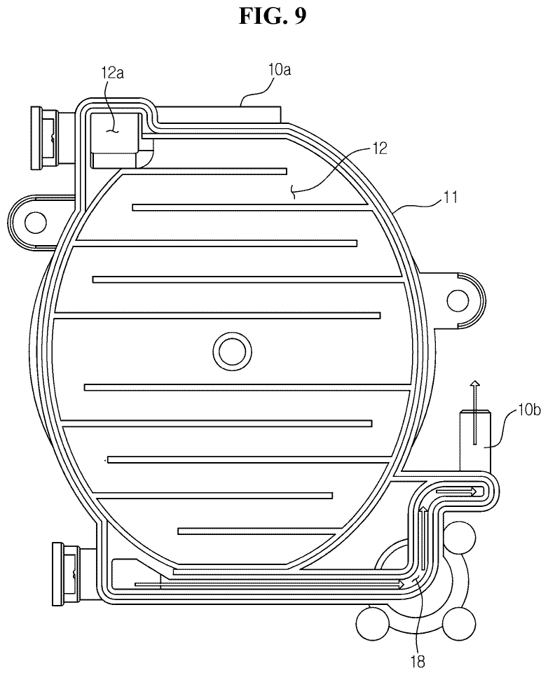

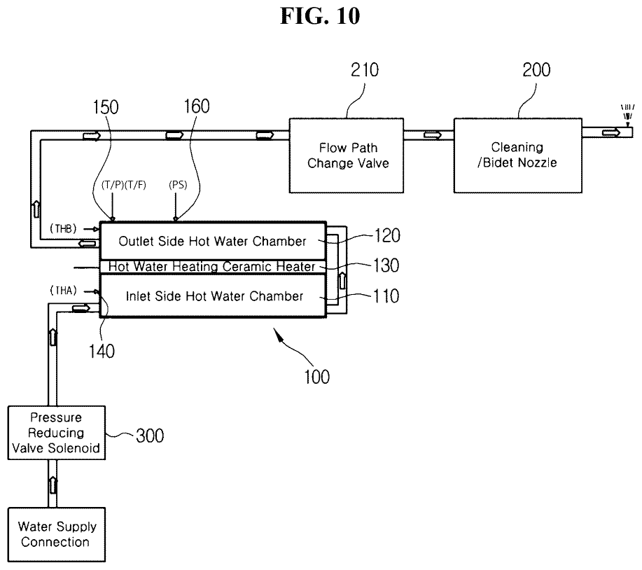

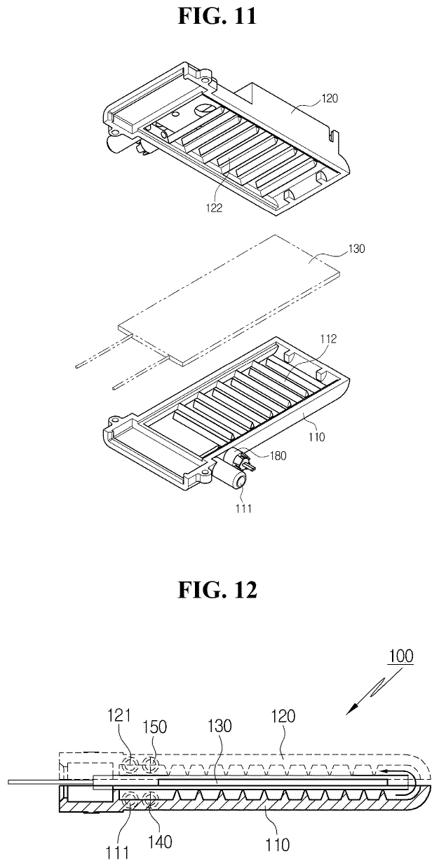

FIGS. 1 and 2 are perspective views of an instant hot water module for bidet cleaning according to an embodiment of the present disclosure when viewed from up and down. FIG. 3 is an exploded perspective view of FIG. 1. FIG. 4 is an exploded perspective view illustrating an induction heater of FIG. 3. FIG. 5 is a combined side view of FIG. 4. FIGS. 6 to 9 are plan views illustrating a path from the intake of water to the discharge of water.

Referring to FIGS. 1 and 2, an instant hot water module 1 for bidet cleaning according to an embodiment of the present disclosure may include a chamber 10. A flow path may be formed inside the chamber 10. The chamber 10 may include an inlet 10a of water and an outlet 10b of hot water.

As illustrated in FIG. 4, the chamber 10 may be separated into a one-side chamber 11 and an other-side chamber 16.

As illustrated in FIGS. 4 and 6, an inlet flow path 12 may be formed inside the one-side chamber 11.

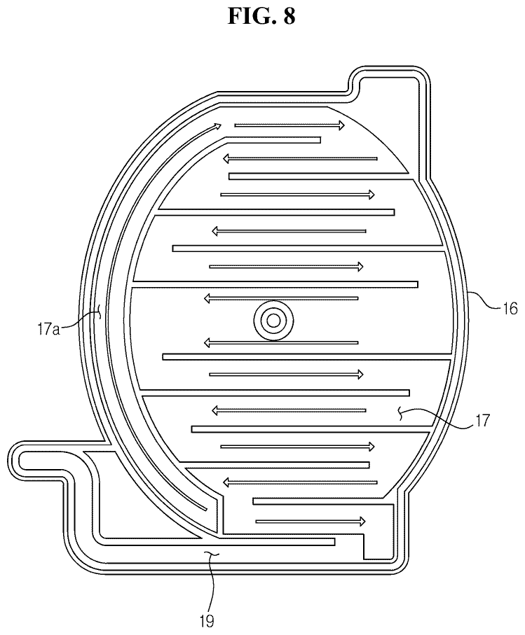

As illustrated in FIG. 8, an outlet flow path 17 may be formed in the other-side chamber 16.

The inlet 10a and the outlet 10b may be formed in the one-side chamber 11.

The inlet flow path 12 may be an inlet flow path of water flowing in the one-side chamber 11 as illustrated by a black arrow in FIG. 6.

The outlet flow path 17 may include an arc flow path 17a with one side open as illustrated by a white arrow in FIG. 8. The arc flow path 17a may turn the flow path as illustrated by the white arrow in FIG. 8.

The outlet flow path 17 may be an outlet flow path of water flowing in the other-side chamber 16 as illustrated by the white arrow in FIG. 8.

The inlet flow path 12 and the outlet flow path 17 may face each other up and down.

A surface 19 covering an upper surface of an outlet flow path 18 may be formed in the other-side chamber 16 facing the outlet flow path 18 of the one-side chamber 11.

By forming both the inlet 10a and the outlet 10b in the one-side chamber 11 through the configuration of the arc flow path 17a and the outlet flow path 18, a thickness of the other-side chamber 16 can be made as thin as possible, thereby contributing to weight reduction and miniaturization.

Referring to FIGS. 3 and 4, the instant hot water module 1 for bidet cleaning according to the present embodiment may include a metal plate 20. The metal plate 20 may be mounted inside the chamber 10. That is, the metal plate 20 may separate the inside of the chamber 10 into the inlet flow path 12 and the outlet flow path 17.

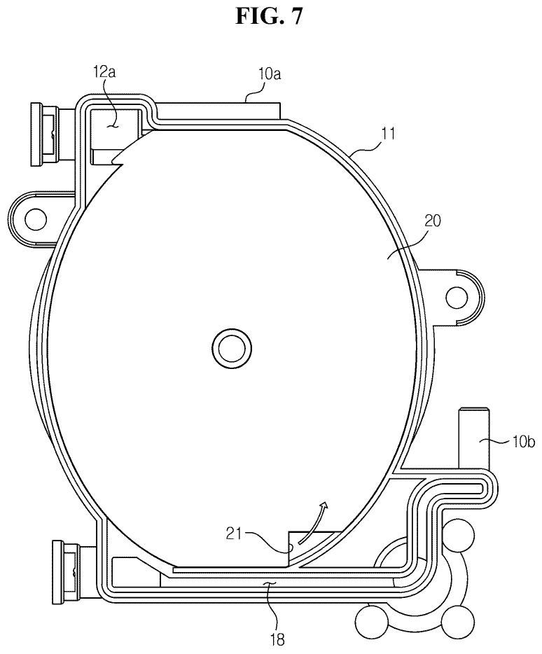

A communication groove 21 may be formed in the metal plate 20. The communication groove 21 may be a passage connecting the inlet flow path 12 and the outlet flow path 17. In addition, the metal plate 20 does not block a starting groove 12a of the inlet flow path 12 as illustrated in FIG. 7. The starting groove 12a may have a U-shape.

Referring to FIG. 3, the instant hot water module 1 for bidet cleaning according to the present embodiment may include an induction heater 30. The induction heater 30 is a heater that uses an induced current generated by a magnetic field as a heat source. When the metal plate 20 is placed on the heater, an eddy current is generated in the metal plate 20 by an electromagnetic induction phenomenon, and the metal plate 20 may instantaneously generate strong heat by Joule heat.

The induction heater 30 may include a magnetic induction coil 31. The magnetic induction coil 31 may be arranged to be in contact with the one-side chamber 11 as illustrated in FIG. 5, and thus increased energy of magnetic induction may allow the metal plate 20 to instantaneously generate heat, thereby rapidly increasing a temperature of water inside the chamber 10.

The induction heater 30 may include a magnet 33. If there is no magnet 33, magnetic induction energy of the magnetic induction coil 31 may be dispersed. To prevent this, if the induction heater 30 includes the magnet 33, the magnetic induction of the magnetic induction coil 31 may be focused toward the metal plate 20, thereby doubling an intensity of the energy.

The induction heater 30 may include a case 35. The case 35 may have a cylindrical shape with one side open. The magnetic induction coil 31 and the magnet 33 may be accommodated in the case 35. An air flow port 37 may be formed in a bottom plate 36 of the case 35.

The induction heater 30 may include a blower fan 38. The blower fan 38 may be installed to be in contact with a flow path of the bottom plate 36. The blower fan 38 may suck external air and cool the magnetic induction coil 31 through the air flow port 37.

Since water is heated instantaneously by the induction heater 30 as described above, power consumption can be reduced, temperature control can be precisely performed, and in particular, peripheral components can be simplified and miniaturized.

Referring to FIGS. 1 and 3, the instant hot water module 1 for bidet cleaning according to the present embodiment may include a printed circuit board (PCB) 40. The PCB 40 may drive and control the induction heater 30 and the blower fan 38, etc.

A heat dissipation part 41 may be installed on the PCB 40.

The heat dissipation part 41 may include a heat dissipation plate 42. The heat dissipation plate 42 may have any configuration that can absorb and release heat, such as a heat sink.

The heat dissipation part 41 may include a pipe 43. The pipe 43 may be installed to pass through the heat dissipation plate 42. The pipe 43 may be a heat exchange pipe through which water, such as tap water, enters and exits through a solenoid valve. In other words, water passing through the pipe 43 may be preheated by heat exchange with the heat dissipation plate 42 and then may be introduced through the inlet 10a.

Through the configuration of the heat dissipation part 41, overheating of the PCB 40 can prevented, and the same heat generation can be provided with low power consumption because the water introduced in the chamber 10 is in a preheated state.

Some embodiments or other embodiments of the present disclosure described above are not mutually exclusive or distinct from each other. Configurations or functions of some embodiments or other embodiments of the present disclosure described above can be used together or combined with each other.

It is apparent to those skilled in the art that the present disclosure can be embodied in other specific forms without departing from the spirit and essential features of the present disclosure. Accordingly, the above detailed description should not be construed as limiting in all aspects and should be considered as illustrative. The scope of the present disclosure should be determined by rational interpretation of the appended claims, and all modifications within an equivalent scope of the present disclosure are included in the scope of the present disclosure.

[Description of Reference Numerals]

| | |
|---|---|
| 1: instant hot water module for | 10: chamber |
| bidet cleaning | |
| 10a: inlet | 10b: outlet |
| 11: one-side chamber | 12: inlet flow path |
| 12a: starting groove | 16: other-side chamber |
| 17: outlet flow path | 17a: arc flow path |
| 18: outlet flow path | 20: metal plate |
| 21: communication groove | 30: induction heater |
| 31: magnetic induction coil | 33: magnet |
| 35: case | 36: bottom plate |
| 37: air flow port | 38: blower fan |
| 40: PCB | 41: heat dissipation part |
| 42: heat dissipation plate | 43: pipe |

1. An instant hot water module for bidet cleaning comprising:
a chamber (10) including an inlet (10a) of water and an outlet (10b) of hot water;
a metal plate (20) separating an inside of the chamber (10) into an inlet flow path and an outlet flow path; and
an induction heater (30) arranged to be in contact with the chamber (10),
wherein the induction heater (30) allows the metal plate (20) to generate heat by a magnetic induction phenomenon and heats the water,
wherein the chamber (10) includes a one-side chamber (11) and an other-side chamber (16),
wherein the inlet (10a) and the outlet (10b) are formed in the one-side chamber (11),
wherein the inlet flow path is a one-side chamber inlet flow path (12) starting from a starting groove (12a) formed in the one-side chamber (11),
wherein the starting groove (12a) communicates with the inlet (10a),
wherein the outlet flow path includes:
an arc flow path (17a) with one side open, the arc flow path (17a) turning the one-side chamber inlet flow path (12) in the other-side chamber (16);
an other-side chamber outlet flow path (17) formed in the other-side chamber (16) and communicating with the arc flow path (17a) with one side open;
a one-side chamber outlet flow path (18) formed in the one-side chamber (11) and communicating with the outlet (10b); and
a surface (19) formed in the other-side chamber (16) facing the one-side chamber outlet flow path (18) and covering an upper surface of the one-side chamber outlet flow path (18),
wherein the metal plate (20) includes a communication groove (21) that communicates the one-side chamber inlet flow path (12) with the arc flow path (17a) with one side open.

2. The instant hot water module for bidet cleaning of claim 1, wherein the induction heater (30) includes:
a magnetic induction coil (31); and
a magnet (33) arranged to be in contact with the magnetic induction coil (31) and focusing a magnetic induction direction of the magnetic induction coil (31) toward the metal plate (20).

3. The instant hot water module for bidet cleaning of claim 2, further comprising:
a printed circuit board (PCB) (40) driving and controlling the induction heater (30),
wherein a heat dissipation part (41) is installed on the PCB (40),
wherein the heat dissipation part (41) includes:
a heat dissipation plate (42) absorbing and releasing heat from the PCB (40); and
a pipe (43) installed to pass through the heat dissipation plate (42),
wherein the pipe (43) exchanges heat with the heat dissipation plate (42) while the water passes through the pipe (43), and
wherein the heat exchanged water is introduced into the inlet (10a).
